(19) United States
(12) Patent Application Publication
(10) Pub. No.: US 2023/0132758 A1
(43) Pub. Date: May 4, 2023

(54) METHOD FOR QUALIFYING BATTERY QUALITY VIA OPERANDO HEAT FLOW RATE SENSING

(71) Applicants: FAURECIA SYSTEMES D'ECHAPPEMENT, NANTERRE (FR); COLLEGE DE FRANCE, Paris (FR)

(72) Inventors: Selma BEN SAAD, MONTBÉLIARD (FR); Jean-Marie TARASCON, PARIS (FR); Laura ALBERO BLANQUER, PARIS (FR); Jiaqiang HUANG, PARIS (FR)

(21) Appl. No.: 17/916,130

(22) PCT Filed: Apr. 3, 2020
(86) PCT No.: PCT/IB2020/000326

§ 371 Date: Sep. 30, 2022

(51) Int. Cl. G01K 11/3206; H01M 10/48

(52) U.S. Cl. CPC G01K 11/3206; H01M 10/486

(57) ABSTRACT

A method for selecting between a first battery cell and a second battery cells includes sensing a total generated heat flow rate emitted by the first battery cell and the second battery cells. The method further includes recording, for the first and second battery cells, first and second sets of heat flow rate data related to the total generated heat flow rate emitted by the first and second battery cells, respectively, over their first charge. The method further includes comparing the first set of heat flow rate data with the second set of heat flow rate data, and selecting one of the first or second battery cells according to the comparison between the first set of heat flow rate data with the second set of heat flow rate data.

### CROSS-REFERENCE TO RELATED APPLICATIONS

This application is the US national phase of PCT/IB2020/000326, which was filed on Apr. 3, 2020.

### FIELD OF THE DISCLOSURE

The disclosure relates to the field of batteries, and more particularly to the field of testing the formation of the solid electrolyte interface layer (SEI) for batteries, which includes, but is not limited to, Lithium ion (Li-ion) and Sodium-ion (Na-ion) batteries.

### BACKGROUND

With batteries being increasingly used in both the transport and power sectors, there exists a need to increase their reliability and performance.

It is well-known in the field of batteries that the formation of the SEI layer, a passivating film that results from the self-limited partial catalytic decomposition of the electrolyte at the electrode surfaces for potentials beyond its range of thermodynamic stability, is one of the major factors influencing the performance of the battery over time. Indeed, even though the formation of the SEI Layer is essential for the battery to function, if it occurs in excess, it may lead to undesirable lithium ions consumption, significant increases in impedance, and the reduction of the active electrode area, leading to a decrease of the performance of the battery over time. As such, the formation of the SEI layer, which mainly controls the cell lifetime, is a critical and expensive step in cell manufacturing, rendering the protocols as trade secrets among the manufacturers.

In order to improve the formation of the SEI layer of a battery for given electrodes, it is common practice for battery manufacturers to introduce additives into its electrolyte. Such additives alter the overall electrochemistry of the battery and usually help stabilizing the SEI layer. However, at present it is not possible to know whether the modification of the electrolyte has improved the SEI layer formation, that is, in a way that will not affect the long-term performance of the battery, at an early stage of the battery life. It is only after performing a long series of charge-discharge cycles, i.e. after actually witnessing the effects of a wrongly formed SEI layer on the battery performance, that it can be realized.

There is therefore a need to be able to determine how the composition of an electrolyte can improve the formation of the SEI layer of a battery has formed correctly at an early stage of the battery life.

### SUMMARY

The disclosure provides a method for selecting between a first battery cell and a second battery cell, wherein the method comprises the following steps:
sensing a total generated heat flow rate emitted by a first battery cell,
   recording a first set of heat flow rate data related to the total generated heat flow rate emitted by the first battery cell over a first charge of the first battery cell,
   sensing a total generated heat flow rate emitted by a second battery cell,
recording a second set of heat flow rate data related to the total generated heat flow rate emitted by the second battery cell over a first charge of the second battery cell,
   comparing the first set of heat flow rate data with the second set of heat flow rate data, and
   selecting between one of the first and second battery cells according to the comparison between the first set of heat flow rate data with the second set of heat flow rate data.

The term “first charge” here relates to the very first time the battery cell is ever charged, i.e. the charge that is usually performed by the battery cell manufacturer before it is even commercialized. In addition, the term “over a first charge” is to be understood as over the time necessary to obtain a full charge of the battery cell.

The disclosure is based on the realization that, considering the SEI layer formation is caused by a surface decomposition of the electrolyte that is governed by electrochemical/chemical reactions, it can be monitored through the heat flow rate associated to such reactions. In other words, by observing and analysing thermal events, such as a sharp rise in heat flow rate, one can determine if a SEI layer has been correctly formed.

Hence, by recording heat flow rate data emitted by a first battery over its first charge, during which the SEI layer is formed, and comparing it to the heat flow rate data emitted by a second battery over its first charge, one can predict which battery will perform better in the long run. Indeed, by comparing thermal events, such as sharp rises in heat flow rate between two batteries, or by comparing the heat emitted by a battery at a particular moment of the charge, the battery whose SEI layer has formed in a more stable way can be identified.

The disclosure therefore provides a way of benchmarking and identifying suitable electrolyte formulae and defining optimized battery formatting protocols in a much faster and much cheaper way, which is a tremendous improvement for battery manufacturers.

Preferably, in order to facilitate the comparison, the electrodes of the two batteries are of the same type. They can even have the same composition.

Preferably, also in order to facilitate the comparison, the sensing and recording steps for the first and second batteries are performed at the same temperature.

Preferably, the sensing of the temperature is performed using at least one optical fiber Bragg grating sensor.

Indeed, owing to the temperature sensing using an optical fiber Bragg sensor, the heat flow rate measurement inside the battery cell can be made in a precise, non-invasive and cheap way.

The small size of an optical fiber Bragg grating sensor (less than 200 μm in diameter) enables the non-destructive insertion of a temperature sensing element, which in turn will give access to the heat flow rate, into the battery cells. For instance it can fit in the hollow part of batteries cells, such as 18650-format cylindrical cells. This makes the operando measurements of internal temperatures feasible.

Moreover, the optical fibers can be made of silicon with a polyamide coating, making them able to sustain the harsh chemical environment within the electrolyte of batteries. An optical fiber Bragg grating sensor also does not generate any electromagnetic interferences as it relies on optical signals.

According to a preferred embodiment of the disclosure, the selecting method comprises, before the comparison step, the steps of:
detecting, within the first set of heat flow rate data, if a heat flow rate above a predetermined threshold lasts over 50% of the total span of the first charge of the first battery,
detecting, within the second set of heat flow rate data, if a heat flow rate above a predetermined threshold last over 50% of the total span of the first charge of the second battery.

Indeed, a criterion for determining if the formation of the SEI layer is satisfactory is to consider the heat flow rate over an important span of the charge, i.e. the “width” of the peak of heat flow rate over the first charge of the battery. If the heat flow rate is high over more than 50% of the span of the first charge, it implies the formation of an unstable SEI layer. Thus, if one of the two batteries presents such a feature it can already be considered as a battery cell that will not perform well.

According to a particular embodiment of the disclosure, the selecting method also comprises the following steps:
calculating a first heat value based on the first set of heat flow rate data,
calculating a second heat value based on the second set of heat flow rate data, and
comparing the first heat value and the second heat value, the selection between the first and second battery cells being performed according to the comparison between the first heat value, and the second heat value.

The first heat value is a value of heat, and can thus be expressed in either milliwatts-hour (mWh) or joules (J), or, if normalized, in either milliwatts-hour per gram (mWh/g) or joules per gram (J/g) of an electrode, for example of the negative electrode considering the SEI layer is formed in majority of the negative electrode.

The magnitude of the heat released by the battery cell is an indicator of the electrochemical/chemical reactions occurring within the battery cell, and thus of the formation of the SEI layer. Hence, if one of the two batteries emits more heat at the same moment of their respective first charges, it is likely that its SEI layer is less stable than the SEI layer of the other battery. Therefore, one battery can be chosen over the other. As an alternative, the second heat value can also be the theoretical heat value associated to the chemical reaction associated to the formation of the SEI layer, which can allow to detect if more heat than expected is recorded, meaning that the SEI layer is unstable.

Preferably, the steps of calculating and comparing the first and second heat values are not performed if the result of one of the detection steps is positive. Indeed in that case, the detection steps are sufficient to be able to select between the two batteries: the battery with a positive detection result will not be chosen.

According to a first variant of the disclosure, the first heat value corresponds to the integral of the heat flow rate generated by the first battery before a predetermined percentage of the first charge, for example before 30% of the first charge of the first battery, and the second heat value corresponds to the integral of the heat flow rate generated by the second battery over said predetermined percentage of the first charge of the second battery.

Indeed it has been observed that most of the reactions linked to the formation of the SEI layer occur at the beginning of the first charge of a battery, for example within the first 30% of the charge, and that heat emitted afterwards is probably due to other electrochemical/chemical reactions. Thus, it is more efficient for the testing method to compare the heat values emitted at the beginning of the first charge.

According to a another variant of the disclosure, the first heat value corresponds to the integral of the peaks of heat flow rate generated by the first battery before a predetermined percentage of the first charge, for example before 30% of the first charge of the first battery, and the second heat value corresponds to the integral of the heat flow rate generated by the second battery over said predetermined percentage of the first charge of the second battery. This is because the reactions linked to the formation of the SEI layer are linked to peaks of heat flow rate as such reactions are electrochemical and/or chemical reactions.

The disclosure also relates to a selecting device for selecting between two battery cells, comprising:
a first heat flow rate sensor able to sense the heat flow rate emitted by a first battery cell and a second battery cell,
a second heat flow rate sensor able to sense the heat flow rate emitted by a second battery cell,
a memory for recording a first set of heat flow rate data sensed by first the heat flow rate sensor relating to the first battery cell, and a second set of heat flow rate data sensed by the second heat flow rate sensor relating to the second battery cell, and
a processor,

the processor being able to compare the first set of heat flow rate data with the second set of heat flow rate data, and to select between one of the first or second battery cells according to the comparison between the first set of heat flow rate data with the second set of heat flow rate data.

Preferably, for the reasons explained above, the heat flow rate sensor of the device includes at least one optical fiber Bragg grating sensor.

### BRIEF DESCRIPTION OF THE FIGURES

The disclosure will be better understood in view of the following description, referring to the annexed Figures in which:

FIG. 1 is a schematic view of a first and second battery cell and a selecting device according to the disclosure;

FIG. 2 is a cut-out view in perspective of one of the first and second battery cell of FIG. 1 in which an internal temperature sensor of the selecting device according to the disclosure is inserted;

FIG. 3 is a series of graphs showing the voltage and heat flow rate for a Na-ion Na₃V₂(PO₄)2F₃/hard carbon (NVPF/HC) cell with 1M NaPF₆ in DMC electrolyte over a state of charge of the battery, at a temperature of 25° C.;

FIG. 4 is a series of graphs showing the voltage and heat flow rate for a Na-ion Na₃V₂(PO₄)2F₃/hard carbon (NVPF/HC) cell with a 1M NaPF₆ in EC-DMC (NP30) electrolyte over a state of charge of the battery, at a temperature of 25° C.;

FIG. 5 is a series of graphs showing the voltage and heat flow rate for a Na-ion Na3V₂(PO4)2F₃/hard carbon (NVPF/HC) cell with a 1M NaPF₆ in EC-DMC (NP30) electrolyte over a state of charge of the battery, at a temperature of 55° C.; and

FIG. 6 is a series of graphs showing the voltage and heat flow rate for a Na-ion Na₃V₂(PO₄)2F₃/hard carbon (NVPF/HC) cell with a customized electrolyte (Magic B) over a state of charge of the battery, at a temperature of 55° C.

### DETAILED DESCRIPTION

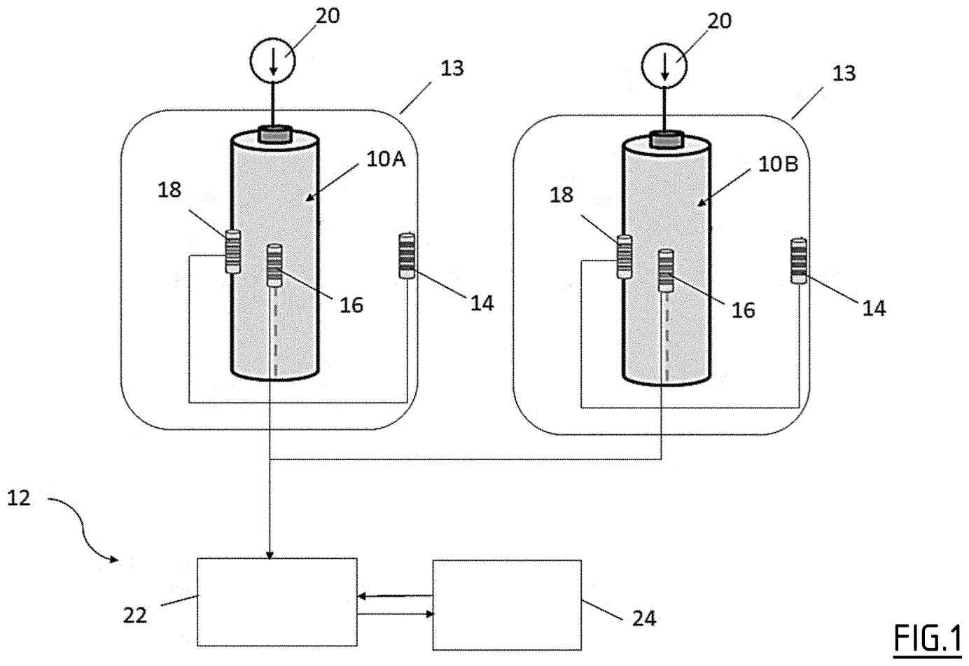

A first battery cell 10A, a second battery cell 10B and a selecting device for selecting between two battery cells, hereinafter named selecting device 12, according to the disclosure are shown on FIG. 1.

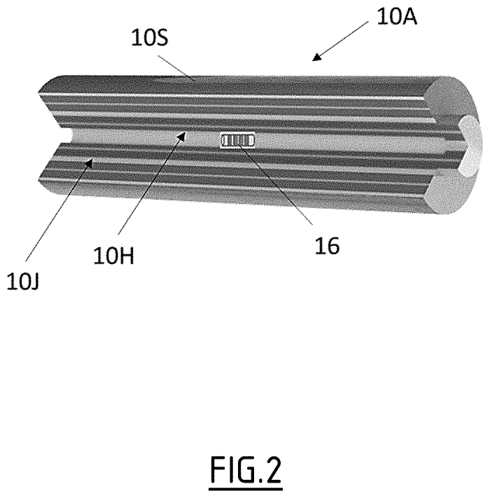

Battery cells 10A and 10B, one of which (battery cell 10A) is shown in FIG. 2, are for example a commercial Na-ion 18650 battery cell which comprises a circular cross-section and a central hollow section 10H within a jelly roll 10J. The jelly roll 10J itself comprises the positive electrode and negative electrode and a plurality of separators. Obviously, other formats of the battery cells such as pouch, prismatic, and coin cells can be used, as well as other electrode and electrolyte compositions as will be mentioned below.

Testing device 12 comprises a heat flow rate sensor 13 able to sense the heat flow rate emitted by first battery cell 10A and a heat flow rate sensor 13 to sense the heat flow rate emitted by second battery cell 10B.

In this particular embodiment of the disclosure, the heat flow rate sensors 13 are calorimeters. Each calorimeter 13 comprises a temperature sensor 14 intended to sense and measure the ambient temperature T_{Ambient} of the environment surrounding the battery cell 10A, 10B.

Preferably, the ambient temperature sensors 14 are optical Fiber Bragg grating sensors, which will be from now on designated as “FBGs”. Said FBG will be referred to as “ambient FBGs” 14.

Each calorimeter 13 also comprises a temperature sensor 16 intended to sense and measure an internal temperature Tᵢₙₜₑᵣₙₐₗ inside the battery cell 10A, 10B. Internal temperature sensor 16 is preferably placed inside the hollow section 10H of the jelly roll. Internal temperature sensor 16 is an optical Fiber Bragg grating sensors, which will be from now on designated as internal FBGs 16.

Each calorimeter 13 also comprises a temperature sensor 18 intended to sense and measure the surface temperature T_{surface} of the battery cell 10A, 10B. Here, the surface temperature 18 sensor is placed on the radial surface 10S of the battery so that the surface temperature sensor 18 and the internal temperature sensor 16 are aligned on a local radius of the circular cross-section, as shown on FIG. 1.

Calorimeter 13 also comprises an electrical power source 20 for charging/discharging the batteries 10A, 10B. In a variant, the selecting device 12 may comprise just one electrical power source 20 for charging/discharging the batteries 10A, 10B. Said source may be a potentiostat able to generate an alternate galvanostatic pulse at a medium frequency such as 2 Hz.

Selecting device 12 also comprises a memory 22 for recording a first set of heat flow rate data sensed by the calorimeter 13 relating to the first battery cell 10A and a second set of heat flow rate data sensed by the calorimeter 13 relating to the second battery cell 10B. Such a memory can be an external flash disk, a hard disk, a flash memory, etc. or any type of data recording device, or be part of the same device as the temperature sensors. For instance, when using an optical interrogator which obtains and converts the optical signal (variation of the wavelength due to the variation of temperature) from the optical fiber Bragg grating sensor into a temperature signal, said interrogator may also record the temperature signal.

In this particular embodiment of the disclosure, memory 22 also records the temperatures sensed by the temperature sensors 14, 16, 18, which will be used to compute the first and second sets of heat flow rate data as will be seen below. It should be noted that a separate memory may be used to record the temperatures.

Selecting device 12 also comprises a processor 24 able to compare the first set of heat flow rate data with the second set of heat flow rate data, and to select one of the first 10A or second 10B battery cells according to the comparison between the first set of heat flow rate data with the second set of heat flow rate data as will be explained below.

In this particular embodiment of the disclosure, the processor 24 also computes, during calibration of the device, characteristic thermal attributes of each battery cell 10A, 10B using a set of internal, surface and ambient temperatures recorded over a predetermined calibration time period, named calibration temperatures, during which the battery is subjected to current emitted by the electrical power source 20, as will be explained below. It should be noted that a separate processor may be used to obtain characteristic thermal attributes of the battery cells 10A, 10B.

Here the characteristic thermal attributes computed by processor 24 are based on a predetermined thermal equivalent circuit of the battery. For example, said thermal equivalent circuit is based on the partition of the overall generated heat flow rate, between the capacitive heat flow rate remaining within the battery and the dissipation heat flow rate dissipated from the battery to its ambient environment, as expressed in the equation below:

$$\dot{Q} = {MC}_{p} \frac{dT}{dt} + \dot{q} \qquad [ Math 1 ]$$

where \dot{Q} is the overall generated heat flow rate, q is the dissipation heat flow rate from the battery cell to its ambient environment, i.e. the dissipated heat flow rate, M is the mass of the battery cell, Cₚ is the specific heat capacity of the battery cell at constant pressure, i.e. isobaric heat capacity, T is the temperature of the battery cell (here the volume-weighted average temperature is used), and t is time. \dot{Q} and \dot{q} are defined as positive if heat is released by the battery cell.
The thermal equivalent circuit is also based on the assumption that the internal temperature, Tᵢₙₜₑᵣₙₐₗ and the surface temperature T_{surface} of the battery are uniform, respectively, that the internal heat transfer resistances within the battery can be combined into a single one hereby named Rᵢₙ and that similarly, the external heat resistances between the surface of the battery and its ambient environment are combined into a single one hereby named Rₒᵤₜ.

Based on the thermal equivalent circuit, the heat flow rate \dot{q} follows the two following equations:

$$\dot{q} = \frac{{T}_{Surface} - {T}_{Ambient}}{{R}_{out}} or \dot{q} = \frac{{T}_{Internal} - {T}_{Surface}}{{R}_{in}} \qquad [ Math 2 ]$$

Considering this choice of thermal equivalent circuit, in this particular embodiment of the disclosure, the characteristics thermal attributes of the battery computed by the processor 24 during calibration of calorimeter 13 are the internal thermal resistance Rᵢₙ between the centre and the surface of the battery cell, the outside thermal resistance Rₒᵤₜ between the surface of the battery cell and the ambient environment, and the product MCₚ of the cell's mass M and isobaric heat capacity Cₚ.

In order to calibrate these parameters, an alternate galvanostatic pulse of 2 Hz is applied by the electrical power source 20 to the battery cell and the evolution of potential is recorded over time by memory 22. The total generated heat flow rate is known from the equation:

\dot{Q}=P= [symbol] _{cycle}IV [Math 3]

where P is the electrical power, with I and V being the current and voltage, respectively.

Then, processor 24 determines, based on the set of calibration temperatures, a steady state of the temperatures and a transient state of the temperatures, and assigns the temperatures recorded in the memory 22 to either the steady state or the transient state. The steady state is reached when all the generated heat is dissipated, i.e. when the total generated heat flow rate \dot{Q} is equal to the dissipation heat flow rate \dot{q}, because the temperatures become stable.

Using the set of calibration temperatures assigned to the steady state, hereby named steady temperatures T_{SInternal}, T_{SSurface} and T_{SAmbient}, and the electrical power delivered to the battery cell by the power source 20, processor 24 computes the internal thermal resistance Rᵢₙ and the outside thermal resistance Rₒᵤₜ.

In other words, knowing the total generated heat flow rate Q linked to the electrical power delivered to the battery cell by the power source 20 and the steady temperatures T_{SInternal}, T_{SSurface} and T_{SAmbient}, measured by the internal FBG 16, the surface FBG 18 and the ambient FBG 14, processor 24 can compute Rₒᵤₜ and Rᵢₙ using the equations:

$$\dot{q} = \frac{{T}_{SSurface} - {T}_{SAmbient}}{{R}_{out}} or \dot{q} = \frac{{T}_{SInternal} - {T}_{SSurface}}{{R}_{in}} \qquad [ Math 4 ]$$

Having computed the characteristic thermal attributes Rₒᵤₜ, Rᵢₙ based on the set of calibration temperatures assigned to the steady state T_{SInternal}, T_{SSurface} and T_{SAmbient}, processor 24 computes the dissipation heat flow rate q dissipated from the battery cell to its environment in a steady state.

Subsequently, processor 24 obtains the factor MCₚ based on the set of calibration temperatures assigned to the transient state, the electrical power delivered to the battery cell by the power source 20 during the calibration period, which is related to the overall generated heat flow rate \dot{Q} as mentioned earlier and the dissipation heat flow rate q dissipated from the battery cell to its environment.

More particularly, the factor MCₚ is obtained using the equation:

$$\dot{Q} - \dot{q} = {MC}_{p} \frac{dT}{dt} \qquad [ Math 5 ]$$

Here \dot{Q}-\dot{q} are known as described above. Using the recorded temperature assigned to the transient state, which represents the term

$$\frac{dT}{dt} ,$$

the coefficient MCₚ can be obtained a linear fitting performed by processor 24.

After calibration, the characteristic thermal attributes Rₒᵤₜ, Rᵢₙ and Cₚ (here MCₚ) are recorded in memory 22 and can be used for measuring the total heat flow rate generated \dot{Q} by the battery cell towards its ambient environment from a set of internal, surface and ambient temperatures T_{Internal}, T_{Surface} and T_{Ambient}.

A method for operando testing of the solid electrolyte interface (SEI) layer formation of a battery cell according to the disclosure will now be described. This method is carried out using the testing device 12.

According to a first step, the total generated heat flow rate \dot{Q} emitted by the first battery cell 10A is sensed by the first calorimeter 13. The total generated heat flow rate \dot{Q} emitted by the second battery cell 10B is also sensed by the second calorimeter 13, for example at the same time, or sequentially.

A first set of heat flow rate data related to the total generated heat flow rate emitted by the first battery cell 10A over a first charge of the first battery cell 10A and a second set of heat flow rate data related to the total generated heat flow rate emitted by the second battery cell over a first charge of the second battery cell 10B are then recorded.

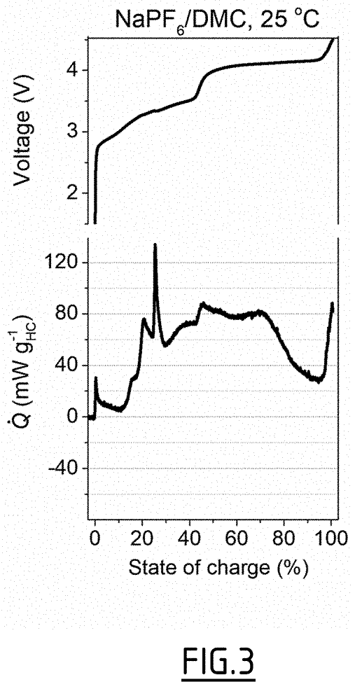

For example, the heat flow rates \dot{Q} are recorded at regular intervals of time over the first charge of the batteries 10A, 10B, from 0% of charge to 100% of the first charge (in practice, the pre-set upper-limit voltage). Then, heat flow rate values may be plotted against the percentage of charge, as shown on FIGS. 3 to 6.

The processor 24 then compares the first set of heat flow rate data with the second set of heat flow rate data, and selecting one of the first 10A or second 10B battery cells according to the comparison between the first set of heat flow rate data with the second set of heat flow rate data.

Preferably, before comparing the first and second set of heat flow rate data, a preliminary detection step is performed for each battery 10A, 10B.

In particular, the processor 24 detects, within the first set of heat flow rate data, if a heat flow rate above a predetermined threshold lasts over 50% of the total span of the first charge of the first battery 10A. In the same way, the processor 24 detects, within the second set of heat flow rate data, if a heat flow rate above a predetermined threshold last over 50% of the total span of the first charge of the second battery 10.

Preferably, the electrodes of the two batteries 10A, 10B are of the same type, so that the composition of their electrolytes as regards to the formation of the SEI layer can be compared.

Hence, for example, a first battery cell 10A, a Na-ion Na3V₂(PO4)2F3/hard carbon (NVPF/HC) cell with 1M NaPF₆ in DMC electrolyte (NaPF₆/DMC) is compared to a second battery cell 10B, a Na-ion Na₃V₂(PO₄)2F₃/hard carbon (NVPF/HC) battery cell with 1M NaPF₆ (NP30) in EC-DMC electrolyte. Both batteries have the same electrodes, Na-ion Na3V₂(PO4)2F3/hard carbon (NVPF/HC), but different electrolytes.

Also preferably, the sensing and recording steps for the first 10A and second 10B batteries are performed at the same temperature, here at 25° C. for both.

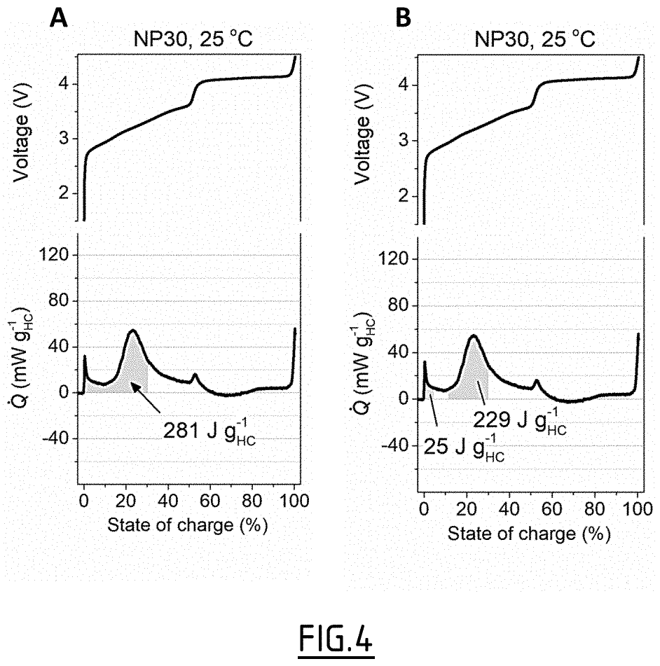

The results are shown on FIG. 3 for the first battery cell, the one with the NaPF₆/DMC electrolyte and on FIG. 4 for the second battery cell, the one with the NP30 electrolyte.

As can be seen on FIG. 3, a heat flow rate above 20 mW g⁻¹, is recorded for a span of more than 50% of the first charge of the first battery cell.

On the other hand, as can be seen on FIG. 4, the heat flow rate is above 20 mW g⁻¹ for only 10% of the total span of the first charge, here between 20% and 30% of the first charge of the second battery cell.

The result of the detection steps are thus positive for the first battery cell, i.e. the one with the 1M NaPF₆ in DMC electrolyte, and negative for the second battery cell, i.e. the one with 1M NaPF₆ (NP30) in EC-DMC electrolyte.

Here, the detection steps are sufficient to be able to select between the two batteries: the second battery, the one with 1M NaPF₆ (NP30) in EC-DMC electrolyte, will be chosen. Indeed, a heat flow rate over 20 mW g⁻¹ throughout the first charge indicates the inability in forming a good protective SEI, owing to the high solubility of DMC-reduced species such as MeOCOONa and MeONa as can be experimentally observed, indicating that the first battery will not perform well. This is consistent with the fact that this type of electrolyte is identified as a badly performing as compared to other Na-ion Na3V₂(PO4)2F3/hard carbon (NVPF/HC) electrolytes.

In this preferred embodiment of the disclosure, the processor 24 first calculates a first heat value based on the first set of heat flow rate data, a second heat value based on the second set of heat flow rate data, and compares the first heat value and the second heat value. The selection between the first 10A or second 10B battery cells is performed according to the comparison between the first heat value and the second heat value.

However, as mentioned above, since the detection steps are sufficient to select between the two batteries if the result of one of the detection is positive, the steps of calculating and comparing the first and second heat values are preferably not performed if the result of one of the detection steps is positive. Therefore, in the example above with the first battery cell 10A, a Na-ion Na3V₂(PO4)2F3/hard carbon (NVPF/HC) cell with 1M NaPF₆ in DMC electrolyte (NaPF₆/DMC) and the second battery cell 10B, a Na-ion Na₃V₂(PO₄)2F₃/hard carbon (NVPF/HC) battery cell with 1M NaPF₆ (NP30) in EC-DMC electrolyte, such a calculation needs not be performed.

According to a first variant of the disclosure, the first heat value corresponds to the integral of the heat flow rate generated by the first battery 10A over a predetermined percentage of the first charge, for example before 30% of the first charge of the first battery 10A, and the second heat value corresponds to the integral of the heat flow rate generated by the second battery 10B over said predetermined percentage of the first charge of the second battery 10B.

For example, a first battery cell 10A, a Na₃V₂(PO₄)2F₃/hard carbon (NVPF/HC) battery cell with 1M NaPF₆ (NP30) in EC-DMC electrolyte is compared to a second battery cell 10B, Na-ion Na₃V₂(PO₄)2F₃/hard carbon (NVPF/HC) cell with a customized electrolyte (denoted “Magic B”). Both batteries have the same electrodes, Na-ion Na3V₂(PO4)2F3/hard carbon (NVPF/HC), but different electrolytes.

Also preferably, the sensing and recording steps for the first 10A and second 10B batteries are performed at the same temperature, here at 55° C. for both.

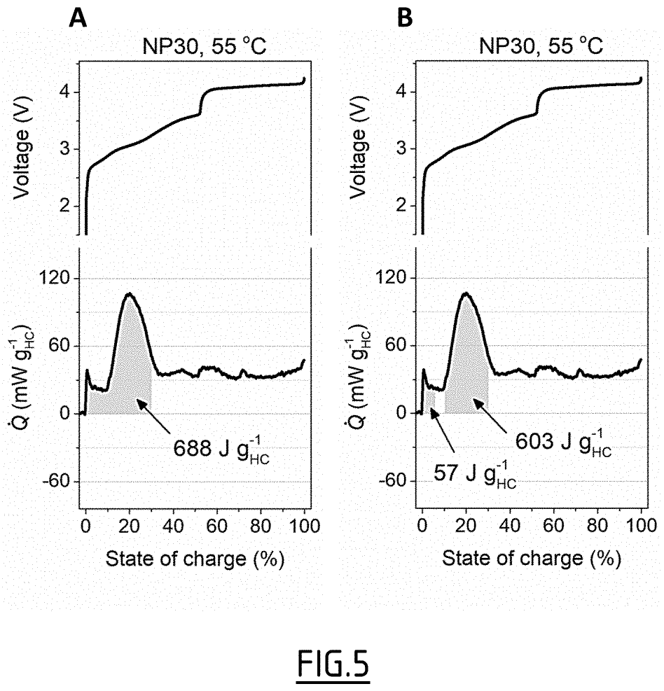

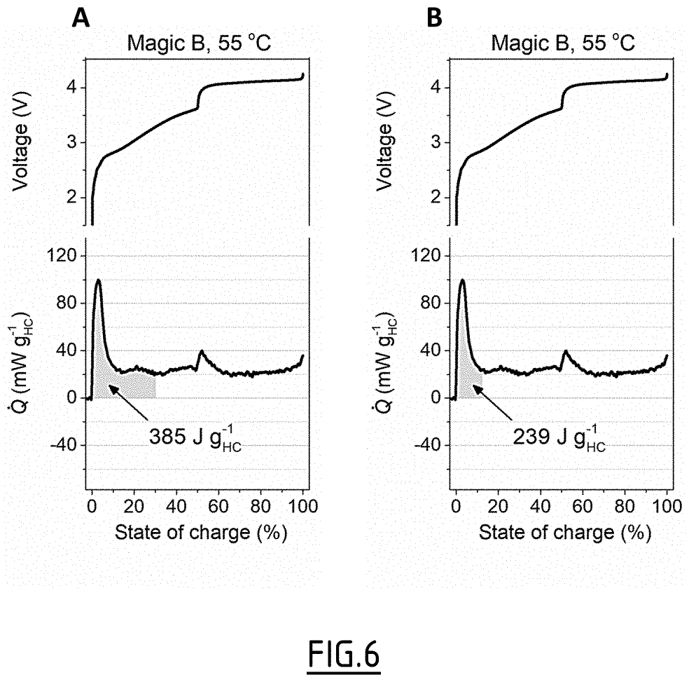

The results are shown on FIG. 5 for the first battery cell, the one with the NP30 electrolyte and on FIG. 6 for the second battery cell, the one with the “Magic B” electrolyte.

First, the detection steps are performed. For both batteries, the one with the NP30 electrolyte and the one with the “Magic B” electrolyte, a heat flow rate above 20 mW g⁻¹ is recorded for less than 50% of the span of the first charge, to be more precise for 20% of the span of the first charge for the NP30 (between 10% and 30% of the charge) and for 10% of the span of the first charge for the Magic B. Thus, the result of both detection steps are negative.

Since the results of the detection steps are negative, the first and second heat values are calculated and then compared.
Referring to FIG. 5, illustrating the results of the recordings for the first battery, the one with the NP30 electrolyte, it can be noted that the first heat value, associated to the integral of the heat flow rate occurring before 30% of the first charge, is 688 J g⁻¹.
Referring to FIG. 6 illustrating the results of the recordings for the second battery, the one with the “Magic B” electrolyte, it can be noted that the second heat value, associated to the integral of the heat flow rate occurring before 30% of the first charge, is 385 J g⁻¹.
From the comparison between the first and second heat values it can be noted that the second heat value (385 J g⁻¹) associated to the second battery with the “Magic B” electrolyte (FIG. 6) is nearly twice less than the first heat value (688 J g⁻¹) associated to the first battery with the NP30 electrolyte (FIG. 5). This allows for a selection of the second battery. Again, this is consistent with experimental results showing a better performance of the “Magic B” battery, which is not a surprise as it is the purpose of using additives.

According to another variant of the disclosure, the first heat value corresponds to the integral of the peaks of heat flow rate generated by the first battery 10A over a predetermined percentage of the first charge, for example before 30% of the first charge of the first battery 10A, and the second heat value corresponds to the integral of the peaks of heat flow rate generated by the second battery 10B over a predetermined percentage of the first charge, for example before 30% of the first charge of the second battery 10B.

Referring back to FIG. 5, illustrating the results of the recordings for the first battery, the one with the NP30 electrolyte, it can be noted that the first heat value is 660 J g⁻¹, which is the sum of the values of the integrals of the two peaks of heat flow rate occurring before 30% of the first charge of the first battery, amounting to 57 J g⁻¹ and 603 J g⁻¹, respectively.
Referring to FIG. 6 illustrating the results of the recordings for the second battery, the one with the “Magic B” electrolyte, it can be noted that the second heat value is 239 J g⁻¹, which is the value of the integral of the sole peak of heat flow rate occurring before 30% of the first charge.
The result of the comparison and the selection steps are the same as in the first variant, as it can be noted that the second heat value (239 J g⁻¹) associated to the second battery with the “Magic B” electrolyte (FIG. 6) is nearly twice less than the first heat value (660 J g⁻¹) associated to the first battery with the NP30 electrolyte (FIG. 5), allowing for a selection of the second battery.

The disclosure is not limited to the presented embodiments and other embodiments will clearly appear to the person of ordinary skill in the art.

For instance, conventional calorimeters sensors may be used to sense the heat flow rate values, a multiplicity of processors may be used in order to perform the computing required by the testing device, and other formats of the battery cells such as pouch, prismatic, and coin cells can be tested.

### LIST OF REFERENCES

10: Battery
10J: Jelly roll of the battery
10H: Hollow part of the battery
12: Testing device
13: Heat flow rate sensor (Calorimeter)
16: Internal temperature sensor
18: Surface temperature sensor
14: Ambient temperature sensor
20: Electrical power source
22: Memory
24: Processor
Cₚ: specific heat capacity of the battery cell at constant pressure
M: mass of the battery cell
\dot{Q}: total heat flow rate released by a battery
\dot{q}: dissipation heat flow rate
Rᵢₙ: internal thermal resistance
Rₒᵤₜ: external thermal resistance
T_{Internal}: internal temperature of the battery cell
T_{Surface}: surface temperature of the battery cell
T_{Ambient}: ambient environment temperature
T_{SInternal}: steady internal temperature of the battery cell
T_{SSurface}: steady surface temperature of the battery cell T_{SAmbient}: steady ambient environment temperature

1. A method for selecting between a first battery cell and a second battery cell, wherein the method comprises the following steps: sensing a total generated heat flow rate emitted by the first battery cell; recording a first set of heat flow rate data related to the total generated heat flow rate emitted by the first battery cell over a first charge of the first battery cell; sensing a total generated heat flow rate emitted by the second battery cell; recording a second set of heat flow rate data related to the total generated heat flow rate emitted by the second battery cell over a first charge of the second battery cell;
comparing the first set of heat flow rate data with the second set of heat flow rate data; and selecting between one of the first or second battery cells according to a comparison between the first set of heat flow rate data with the second set of heat flow rate data.

2. The selecting method according to claim 1, wherein electrodes of the first and the second battery cells batteries are of a same type.

3. The selecting method according to claim 2, wherein the sensing and recording steps for the first and second battery cells are performed at a same temperature.

4. The selecting method according to claim 1, wherein the sensing of the total generated heat flow rate is performed using at least one optical fiber Bragg grating sensor.

5. The selecting method according to claim 1, wherein the method comprises, before the comparison step, the steps of: detecting, within the first set of heat flow rate data, if a heat flow rate above a predetermined threshold lasts over 50% of a total span of the first charge of the first battery; and detecting, within the second set of heat flow rate data, if a heat flow rate above a predetermined threshold last over 50% of a total span of the first charge of the second battery.

6. The selecting method according to claim 1, wherein the method also comprises the following steps: calculating a first heat value based on the first set of heat flow rate data; calculating a second heat value based on the second set of heat flow rate data; and comparing the first heat value and the second heat value, the selection between the first and the second battery cells being performed according to the comparison between the first heat value, and the second heat value.

7. The selecting method according to claim 5, wherein the method also comprises the following steps: calculating a first heat value based on the first set of heat flow rate data; calculating a second heat value based on the second set of heat flow rate data; comparing the first heat value and the second heat value, the selection between the first and the second battery cells being performed according to the comparison between the first heat value, and the second heat value; and
wherein the steps of calculating and comparing the first and the second heat values are not performed if a result of one of the detection steps is positive.

8. The selecting method according to claim 6, wherein the first heat value corresponds to an integral of the heat flow rate generated by the first battery cell before a predetermined percentage of the first charge, and the second heat value corresponds to an integral of the heat flow rate generated by the second battery cell over said predetermined percentage of the first charge of the second battery.

9. The selecting method according to claim 6, wherein the first heat value corresponds to an integral of peaks of heat flow rate generated by the first battery cell before a predetermined percentage of the first charge, and the second heat value corresponds to an integral of peaks of heat flow rate generated by the second battery cell over a predetermined percentage of the first charge.

10. A selecting device for selecting between a first battery cell and a second battery cell, comprising:
a first heat flow rate sensor able to sense a heat flow rate emitted by the first battery cell;
a second heat flow rate sensor able to sense a heat flow rate emitted by the second battery cell;
a memory for recording a first set of heat flow rate data sensed by the first heat flow rate sensor relating to the first battery cell, and a second set of heat flow rate data sensed by the second heat flow rate sensor relating to the second battery cell; and
a processor configured to compare the first set of heat flow rate data with the second set of heat flow rate data, and to select one between the first second battery cells according to a comparison between the first set of heat flow rate data with the second set of heat flow rate data.

11. A testing device comprising the selecting device according to claim 10, wherein the heat flow rate sensor includes at least at least one optical fibre Bragg grating sensor.
